(19) United States
(12) Patent Application Publication
(10) Pub. No.: US 2024/0119135 A1
(43) Pub. Date: Apr. 11, 2024

(54) INDIVIDUAL DETERMINATION DEVICE AND INDIVIDUAL DETERMINATION METHOD FOR TARGET EQUIPMENT

(71) Applicant: MITSUBISHI ELECTRIC CORPORATION, Tokyo (JP)

(72) Inventors: Tsuyoshi KOBAYASHI, Tokyo (JP); Koichi FURUYA, Tokyo (JP)

(73) Assignee: MITSUBISHI ELECTRIC CORPORATION, Tokyo (JP)

(21) Appl. No.: 18/529,782

(22) Filed: Dec. 5, 2023

Related U.S. Application Data
(63) Continuation of application No. PCT/JP2021/023896, filed on Jun. 24, 2021.

(51) Int. Cl. G06F 21/44

(52) U.S. Cl. CPC G06F 21/44

(57) ABSTRACT

An individual determination device for target equipment, includes: a coupling circuit electrically connected to an interface in target equipment, and to detect a signal showing an electromagnetic characteristic from target equipment, to extract an electromagnetic characteristic signal showing an individual characteristic of the target equipment, from the conduction noise detected thereby, and to output the electromagnetic characteristic signal; a characteristic measurement device to receive the electromagnetic characteristic signal from the coupling circuit, and to output individual characteristic data showing the individual characteristic of the target equipment on a basis of the electromagnetic characteristic signal; a storage device to store individual characteristic data showing an electromagnetic individual characteristic of original target equipment; and a comparison and determination device to compare the individual characteristic data from the characteristic measurement device and the individual characteristic data stored in the storage device, and to perform individual determination on the target equipment.

### TECHNICAL FIELD

### Cross Reference to Related Applications

This application is a Continuation of PCT International Application No. PCT/JP2021/023896 filed on Jun. 24, 2021, which is hereby expressly incorporated by reference into the present application.

The present disclosure relates to an individual determination device and an individual determination method for target equipment capable of performing individual determination, such as authenticity determination or individual identification, on target equipment such as electronic equipment or electrical equipment.

### BACKGROUND ART

Patent Literature 1 discloses a technology of, in order to uniquely identify an electronic chip or an integrated circuit, incorporating a physically unclonable function (PUF) into the integrated circuit, thereby making it possible to generate a unique signature specific to the integrated circuit.

### CITATION LIST

### Patent Literature

### Patent Literature 1:

Japanese Unexamined Patent Application Publication (Translation of PCT Application) No. 2013-534062

### SUMMARY OF INVENTION

### Technical Problem

In conventional technologies typified by Patent Literature 1, in order to make it possible to perform individual determination, such as authenticity determination or individual identification, on target equipment such as electronic equipment or electrical equipment, a dedicated circuit including a PUF needs to be disposed inside the target equipment.

The present disclosure is made in view of the above-mentioned point, and it is an object of the present disclosure to provide an individual determination device for target equipment capable of performing individual determination, such as authenticity determination or individual identification, without disposing a dedicated circuit for individual identification in target equipment.

### Solution to Problem

An individual determination device for target equipment according to the present disclosure includes: a coupling circuit that is electrically connected to an interface in target equipment, the coupling circuit being configured to detect a signal showing an electromagnetic characteristic based on a conduction noise that is conducted to the interface in target equipment, to extract an electromagnetic characteristic signal showing an individual characteristic of the target equipment, from the conduction noise detected thereby, and to output the electromagnetic characteristic signal; a characteristic measurement device to receive the electromagnetic characteristic signal from the coupling circuit, and to output individual characteristic data showing the individual characteristic of the target equipment on a basis of the electromagnetic characteristic signal received from the coupling circuit; a storage device to store individual characteristic data showing an electromagnetic individual characteristic of original target equipment; and a comparison and determination device to compare the individual characteristic data from the characteristic measurement device and the individual characteristic data stored in the storage device, and to perform individual determination on the target equipment.

### Advantageous Effects of Invention

According to the present disclosure, the individual determination on the target equipment can be performed using the electromagnetic characteristic inevitably occurring from the target equipment, without adding a special circuit or function to the target equipment.

### BRIEF DESCRIPTION OF DRAWINGS

FIG. 1 is a schematic diagram showing the configuration of an individual determination device according to Embodiment 1;

FIG. 2 is a flowchart about an individual determination method used by the individual determination device according to Embodiment 1;

FIG. 3 is a schematic diagram showing the configuration of an individual determination device according to Embodiment 2; and

FIG. 4 is a flowchart about an individual determination method used by the individual determination device according to Embodiment 2.

### DESCRIPTION OF EMBODIMENTS

### Embodiment 1

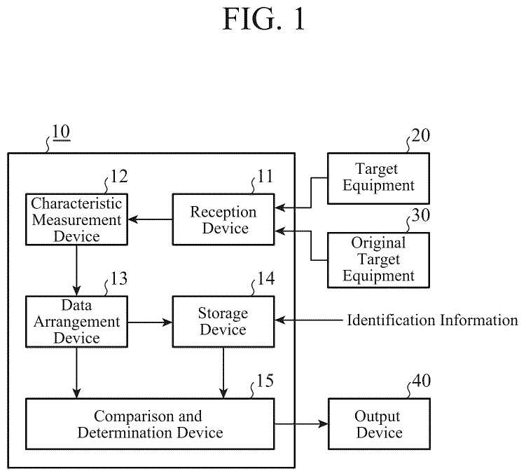

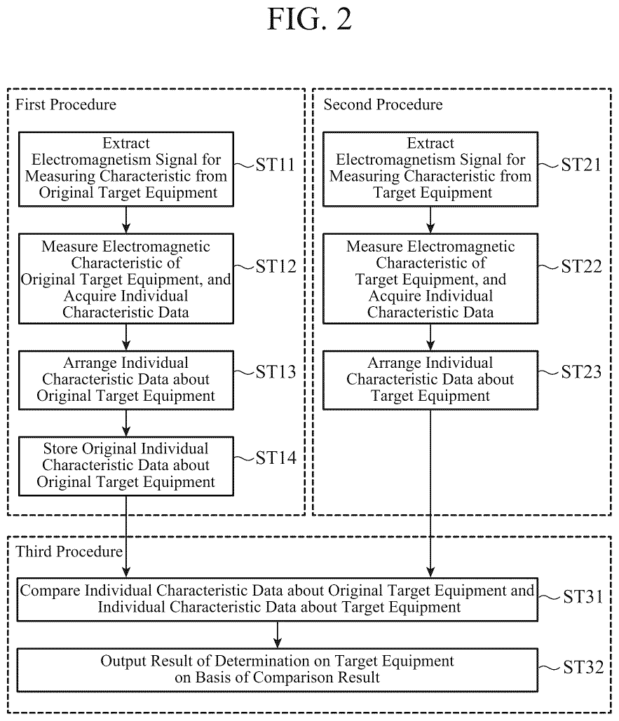

An individual determination device for target equipment (simply abbreviated as an individual determination device hereinafter) 10 according to Embodiment 1 will be explained on the basis of FIGS. 1 and 2.

The individual determination device 10 includes a reception device 11, a characteristic measurement device 12, a data arrangement device 13, a storage device 14, and a comparison and determination device 15, as shown in FIG. 1.

Target equipment 20 is electronic equipment or electrical equipment on which individual determination, such as authenticity determination or individual identification, is to be performed.

Original target equipment 30 is electronic equipment or electrical equipment which is registered in advance before the individual determination is performed on the target equipment 20, and which is a target for individual determination. More specifically, the original target equipment 30 is true electronic equipment or electrical equipment which is provided for the sake of the individual determination on the target equipment 20.

In the following explanation, when it is not necessary to distinguish between the target equipment 20 and the original target equipment 30, they are generically referred to as target equipment in order to avoid the complexity.

In Embodiment 1, target equipment which is a target for the individual determination is electronic equipment or electrical equipment which produces an electromagnetic noise by itself in its operation state.

An electromagnetic noise occurring from target equipment is typically a signal showing an electromagnetic characteristic inevitably occurring from target equipment, and the target equipment exhibits an electromagnetic characteristic which differs depending on factors such as the connection configuration of parts or circuits used in the target equipment, the layer configuration of a printed-circuit board used inside the target equipment, the wiring route for a power supply or signals used inside the target equipment, the wiring route of internal cables used inside the target equipment, the structure of the case of the target equipment, or the like, even though the target equipment has a similar appearance and a similar function.

Further, even though equipment is produced according to the same design, the equipment produces an electromagnetic noise showing an electromagnetic characteristic different from equipment to equipment because of variations in each part and a printed-circuit board, the wiring route of internal cables, the assembly of the case, and so on.

An electromagnetic noise occurring from target equipment contains both a radiated noise radiated from the target equipment into space, and a conduction noise conducted to an interface in the target equipment.

In the explanation of Embodiment 1, an electromagnetic noise is a general term containing both a radiated noise and a conduction noise, and there is a case in which one of electromagnetic noises is shown.

An interface in target equipment is at least a portion such as a power or communication cable, a terminal of the power or communication cable, or the whole or part of the case of the target equipment.

A power or communication cable or a terminal of a power or communication cable is a cable interface, and the whole or part of the case of target equipment or the like is an interface other than the cable interface.

The individual determination device 10 according to Embodiment 1 uses an electromagnetic characteristic of an electromagnetic noise occurring from target equipment, to measure the electromagnetic noise, thereby performing the individual determination, such as authenticity determination of whether it is a genuine product or a non-genuine product, individual identification of the target equipment, or authentication of the target equipment.

The reception device 11 detects a signal showing an electromagnetic characteristic from target equipment (20 or 30), i.e. an electromagnetic noise in Embodiment 1, extracts an electromagnetic signal for measuring an individual characteristic of the target equipment from the electromagnetic noise detected thereby, and outputs an electromagnetic characteristic signal showing the individual characteristic of the target equipment.

The reception device 11 is aimed at a radiated noise, a conduction noise, or both a radiated noise and a conduction noise, as an electromagnetic noise, to receive it.

In the case where the reception device 11 is aimed at a radiated noise as an electromagnetic noise, the reception device 11 is, for example, an electric or magnetic field probe, an antenna, or a transverse electro-magnetic (TEM) cell.

As an alternative, in the case where the reception device 11 is aimed at a conduction noise as an electromagnetic noise, the reception device 11 is, for example, a voltage or current probe, or a coupling circuit such as an artificial mains network (AMN) for power supply terminals or an asymmetric artificial network (AAN) for signal terminals which is used in an electromagnetic compatibility (EMC) test which is a noise test.

As an alternative, in the case where the reception device 11 is aimed at both a radiated noise and a conduction noise as an electromagnetic noise, the reception device 11 is a combination of a device in the case where the device is aimed at a radiated noise as an electromagnetic noise, and a device in the case where the device is aimed at a conduction noise as an electromagnetic noise.

The characteristic measurement device 12 receives the electromagnetic characteristic signal inputted thereto from the reception device 11, and outputs individual characteristic data showing an electromagnetic individual characteristic of the target equipment on the basis of the electromagnetic characteristic signal inputted thereto.

The characteristic measurement device 12 is either an oscilloscope that measures variations in a voltage in a time domain on the basis of the electromagnetic characteristic signal from the reception device 11 which is based on an electromagnetic noise, and that displays and outputs a measurement result as the individual characteristic data which is data showing a waveform, or a spectrum analyzer that measures a voltage level in a frequency domain on the basis of the electromagnetic characteristic signal from the reception device 11, and that displays and outputs a measurement result as the individual characteristic data which is data showing a waveform.

The data arrangement device 13 arranges the individual characteristic data from the characteristic measurement device 12 by eliminating a noise or extracting specific information from the individual characteristic data from the characteristic measurement device 12, and outputs the individual characteristic data arranged thereby.

The noise which is eliminated from the individual characteristic data by the data arrangement device 13 is not the electromagnetic noise from the target equipment (20 or 30), but a noise which is superimposed onto the electromagnetic noise from the target equipment (20 or 30) and which is unnecessary for the individual determination.

The data arrangement device 13 receives an electromagnetic noise from the target equipment a number of times by means of the reception device 11, and calculates the average of the pieces of individual characteristic data from the characteristic measurement device 12 which correspond to the electromagnetic noises which have been received a number of times and sets the average as the individual characteristic data, or extracts a frequency component with small variations and a high signal intensity from the individual characteristic data from the characteristic measurement device 12 and sets the frequency component as the individual characteristic data.

In the case where an oscilloscope is used as the characteristic measurement device 12, the data arrangement device 13 averages a graph of temporal variations in a periodic voltage which is provided by the oscilloscope.

As an alternative, in the case where a spectrum analyzer is used as the characteristic measurement device 12, the data arrangement device 13 averages a spectrum in a specific frequency range which is provided by the spectrum analyzer, or performs noise elimination using a maximum (Max Hold) or a minimum (Min Hold).

As an alternative, as to either only frequencies having certain intensity or more or only a switching frequency and multiples of the switching frequency which are caused by a switching operation in the target equipment, with respect to the noise spectrum in the individual characteristic data from the characteristic measurement device 12, the data arrangement device 13 may extract those frequencies and intensities as a set.

In the case where the individual characteristic data from the characteristic measurement device 12 is stable, or in the case where there is no limit on the memory space of the storage device 14 and the amount of calculation for the determination by the comparison and determination device 15, the data arrangement device 13 does not have to be disposed in the individual determination device 10, and the individual characteristic data from the characteristic measurement device 12 may be inputted directly to the storage device 14 and the comparison and determination device 15.

The storage device 14 stores original individual characteristic data which is defined as a set of the individual characteristic data showing the electromagnetic individual characteristic of the original target equipment 30, and identification information shown by the model name and the serial number, or the like of the original target equipment 30, with the individual characteristic data and the identification information being linked to each other.

The individual characteristic data showing the electromagnetic individual characteristic of the original target equipment 30 corresponds to the individual characteristic data which results from the reception device 11's detection of an electromagnetic noise occurring from target equipment 20 and which is outputted either via the characteristic measurement device 12 and the data arrangement device 13 or via the characteristic measurement device 12.

Further, the original individual characteristic data stored in the storage device 14 is the one in which the identification information about the original target equipment is linked to the individual characteristic data which results from the reception device 11's detection of an electromagnetic noise from the original target equipment 30, and which is outputted via the characteristic measurement device 12 and the data arrangement device 13, or outputted directly via the characteristic measurement device 12.

When the individual characteristic data about the original target equipment 30 is known, what is necessary is just to link the known individual characteristic data to the identification information about the original target equipment 30, and to store the individual characteristic data in the storage device 14.

The original individual characteristic data stored in the storage device 14 is not limited to the one about the single original target equipment 30, and the original individual characteristic data about each of the following pieces of original target equipment: multiple pieces of original target equipment 30 having different model names; and multiple pieces of original target equipment 30 of the same type, but having different serial numbers is stored in the storage device 14 as needed.

The storage device 14 is one generally known, such as a semiconductor memory or a magnetic disk drive (HDD).

The comparison and determination device 15 detects an electromagnetic noise occurring from target equipment 20 by means of the reception device 11, and compares the individual characteristic data about the target equipment 20, which is outputted via the characteristic measurement device 12 and the characteristic measurement device 12 or outputted directly via the data arrangement device 13, and the individual characteristic data in the original individual characteristic data about the original target equipment 30 stored in the storage device 14, to perform individual determination on the target equipment 20.

The individual determination performed by the comparison and determination device 15 is authenticity determination, individual identification, or determination of authentication of the target equipment.

When there is a match between the individual characteristic data about the target equipment 20 and the individual characteristic data in the original individual characteristic data about the original target equipment 30, the comparison and determination device 15 outputs the identification information in the original individual characteristic data about the original target equipment 30 to the output device 40, and also outputs information showing that it is genuine (genuine product) in the case of authenticity determination, or outputs information showing that the target equipment 20 is based on the identification information in the case of individual identification and in the case of determination of authentication of the target equipment.

The “match” used here includes not only a case in which the individual characteristic data is completely the same as the individual characteristic data in the original individual characteristic data, but also a case in which the individual characteristic data is similar one which can be assumed to match the individual characteristic data in the original individual characteristic data. Also in the following explanation, the same applies hereinafter.

Further, when the individual characteristic data in the original individual characteristic data about the original target equipment 30 which matches the individual characteristic data about the target equipment 20 is not present in the storage device 14, the comparison and determination device 15 outputs information showing that it is fake (non-genuine product) in the case of authenticity determination, or outputs information showing that it is a target product not registered in the case of individual identification and in the case of determination of authentication of the target equipment.

Next, an operation of storing the original individual characteristic data about the original target equipment 30 in the storage device 14 and an operation of performing the individual determination on target equipment 20 in the individual determination device 10 according to Embodiment 1 will be explained on the basis of FIG. 2.

First, a first procedure of storing the original individual characteristic data about the original target equipment 30 in the storage device 14, i.e. a storage procedure will be explained.

As shown in step ST11, an electromagnetic noise occurring from the original target equipment 30 is detected by the reception device 11, an electromagnetic signal for measuring an individual characteristic of the original target equipment 30 is extracted from the electromagnetic noise detected by the reception device 11, and an electromagnetic characteristic signal showing the individual characteristic of the original target equipment 30 is outputted to the characteristic measurement device 12. This step ST11 is an acquisition step of acquiring an electromagnetic noise which is a signal showing an electromagnetic characteristic from the original target equipment 30.

Next, the characteristic measurement device 12 measures an electromagnetic characteristic of the original target equipment 30 on the basis of the electromagnetic characteristic signal from the reception device 11, and acquires and outputs individual characteristic data showing the electromagnetic individual characteristic of the original target equipment 30 (step ST12). This step ST12 is an acquisition step of acquiring the individual characteristic data about the original target equipment 30.

The data arrangement device 13 arranges the individual characteristic data from the characteristic measurement device 12 by eliminating a noise or extracting specific information from the individual characteristic data from the characteristic measurement device 12, and outputs the individual characteristic data arranged thereby (step ST13). This step ST13 is an arrangement step of arranging the individual characteristic data about the original target equipment 30.

The individual characteristic data about the original target equipment 30 which is acquired in this way is stored, as original individual characteristic data which is set information containing the individual characteristic data and the identification information, in the storage device 14, with the identification information being linked to the individual characteristic data, and the individual characteristic data (step ST14). This step ST4 is a storage step of storing the original individual characteristic data about the original target equipment 30.

In steps ST11 to ST14, the storage of the original individual characteristic data about the original target equipment 30 in the storage device 14 is completed.

By performing the storage procedure (first procedure) of steps ST11 to ST14 on each of the following pieces of original target equipment: multiple pieces of original target equipment 30 having different model names; and multiple pieces of original target equipment 30 of the same type, but having different serial numbers, the multiple pieces of original individual characteristic data about the multiple types of original target equipment 30 can be stored in the storage device 14.

Next, a second procedure of acquiring the individual characteristic data about target equipment 20 in the individual determination device 10 according to Embodiment 1, i.e. an acquisition procedure, and a third procedure of performing whether or not there is a match between the individual characteristic data about the target equipment 20 and the individual characteristic data about the original target equipment 30, i.e. an individual determination procedure will be explained.

Steps ST21 to ST23 in the second procedure are basically ones in which the acquisition, in steps ST11 to ST13 in the first procedure, of the individual characteristic data about the original target equipment 30 which is based on an electromagnetic noise occurring from the original target equipment 30 is replaced by the acquisition of the individual characteristic data about the target equipment 20 which is based on an electromagnetic noise occurring from the target equipment 20, as shown in FIG. 2.

More specifically, although a detailed explanation is omitted, step ST21 is an acquisition step of acquiring an electromagnetic noise which is a signal from the target equipment 20, the signal showing an electromagnetic characteristic, the acquisition step being one in which the reception device 11 acquires and outputs an electromagnetic characteristic signal showing an individual characteristic of an electromagnetic noise occurring from the target equipment 20.

Step ST22 is an acquisition step of acquiring the individual characteristic data about the target equipment 20, the acquisition step being one in which the characteristic measurement device 12 acquires and outputs the individual characteristic data showing the electromagnetic individual characteristic of the target equipment 20 on the basis of the electromagnetic characteristic signal from the reception device 11.

Step ST23 is an arrangement step in which the data arrangement device 13 arranges the individual characteristic data about the target equipment 20 by eliminating a noise or extracting specific information from the individual characteristic data from the characteristic measurement device 12.

In the third procedure, the comparison and determination device 15 determines whether or not there is a match between the individual characteristic data about the target equipment 20 from the characteristic measurement device 12, the individual characteristic data being acquired in the second procedure and outputted via the data arrangement device 13, and the individual characteristic data in the original individual characteristic data about the original target equipment 30, the original individual characteristic data being acquired in the first procedure and stored in the storage device 14 (step ST31). This step ST31 is a comparison step on the target equipment 20.

The comparison and determination device 15 performs the individual determination on the target equipment 20 on the basis of a result of the comparison in step ST31, and outputs a result of the determination to the output device 40 (step ST32). This step ST32 is an individual determination step on the target equipment 20.

In the case of authenticity determination, when there is a match between the individual characteristic data about the target equipment 20 and the individual characteristic data about the original target equipment 30, the determination result is information which is defined as a set of the identification information about the original target equipment 30 and information showing that it is genuine (genuine product).

Further, in the case of authenticity determination, when the individual characteristic data about the original target equipment 30 which matches the individual characteristic data about the target equipment 20 is not present in the storage device 14, the determination result is information showing that it is fake (non-genuine product).

In addition, in the case of individual identification and in the case of determination of authentication of target equipment, when there is a match between the individual characteristic data about the target equipment 20 and the individual characteristic data about the original target equipment 30, the determination result is information showing that it is target equipment which is based on the identification information about the original target equipment 30 which the target equipment 20 matches.

Further, in the case of individual identification and in the case of determination of authentication of target equipment, when the individual characteristic data about the original target equipment 30 which matches the individual characteristic data about the target equipment 20 is not present in the storage device 14, the determination result is information showing that it is a target product not registered.

The individual determination device 10 according to Embodiment 1 has only to be configured in such a way that the reception device 11 receives at least one of multiple electromagnetic noises occurring from target equipment, and the characteristic measurement device 12 acquires the individual characteristic data about the target equipment.

Further, the individual determination device 10 according to Embodiment 1 has only to be configured in such a way that the reception device 11 receives electromagnetic noises in multiple different operation states of target equipment 20, such as an electromagnetic noise occurring from target equipment 20 when the target equipment 20 starts, and an electromagnetic noise occurring from the target equipment after the start of the target equipment 20 is completed, and the characteristic measurement device 12 acquires the individual characteristic data about the target equipment in each of the states.

Because the individual determination device 10 according to the Embodiment 1 configured in this way includes: the reception device 11 to extract an electromagnetic characteristic signal of target equipment 20 from an electromagnetic noise which is a signal from the target equipment 20, the signal showing an electromagnetic characteristic, and to output the electromagnetic characteristic signal; the characteristic measurement device 12 to output individual characteristic data about the target equipment on the basis of the electromagnetic characteristic signal from the reception device 11; the storage device 14 to store the individual characteristic data about the original target equipment 30; and the comparison and determination device 15 to compare the individual characteristic data from the characteristic measurement device 12 and the individual characteristic data stored in the storage device 14, to perform the individual determination on the target equipment 20, the individual determination device 10 can perform the individual determination on the target equipment 20 using the electromagnetic characteristic inevitably occurring from the target equipment 20 without adding a special circuit or function to the target equipment 20.

Further, because it is not necessary to add a special circuit or function to target equipment 20, individual determination can be performed on already-existing target equipment 20 which does not include a special circuit or function.

In addition, because an electromagnetic characteristic inevitably occurring from target equipment 20 is used, the operation of the target equipment 20 is not influenced even though the individual determination is performed on the target equipment 20.

In addition, because the data arrangement device 13 that arranges the individual characteristic data from the characteristic measurement device 12 by eliminating a noise or extracting specific information from the individual characteristic data from the characteristic measurement device 12, and that outputs the individual characteristic data arranged thereby to the comparison and determination device 15 is disposed, the storage amount of the storage device 14 and the amount of calculation for the determination by the comparison and determination device 15 can be reduced.

The individual characteristic data about the original target equipment 30 to be stored in the storage device 14 is stored, as original individual characteristic data, in the storage device 14 with the identification information showing the original target equipment 30 being linked to the individual characteristic data, and the comparison and determination device 15 outputs the identification information about the original target equipment 30 when there is a match between the individual characteristic data from the characteristic measurement device 12 and the individual characteristic data stored in the storage device 14, so that a result of the individual determination on the target equipment 20 can be acquired from the outputted identification signal, and furthermore, the identification information about the target equipment 20 can be acquired promptly.

The individual characteristic data about the original target equipment 30 to be stored in the storage device 14 is acquired using the reception device 11 and the characteristic measurement device 12 that perform the individual determination on the target equipment 20, so that the individual determination on the target equipment 20 can be performed with a high degree of accuracy.

### Embodiment 2

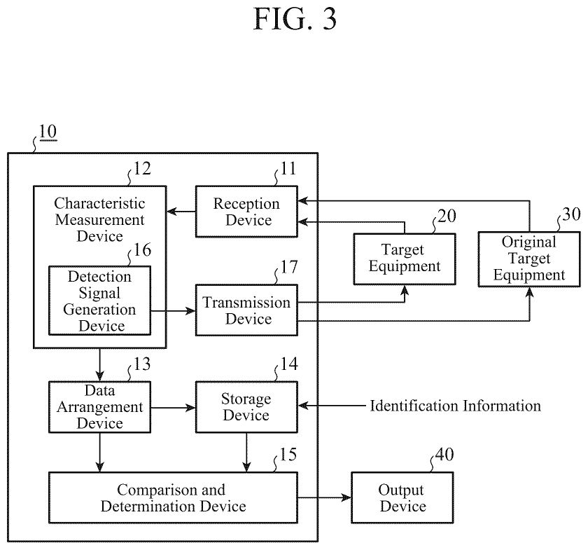

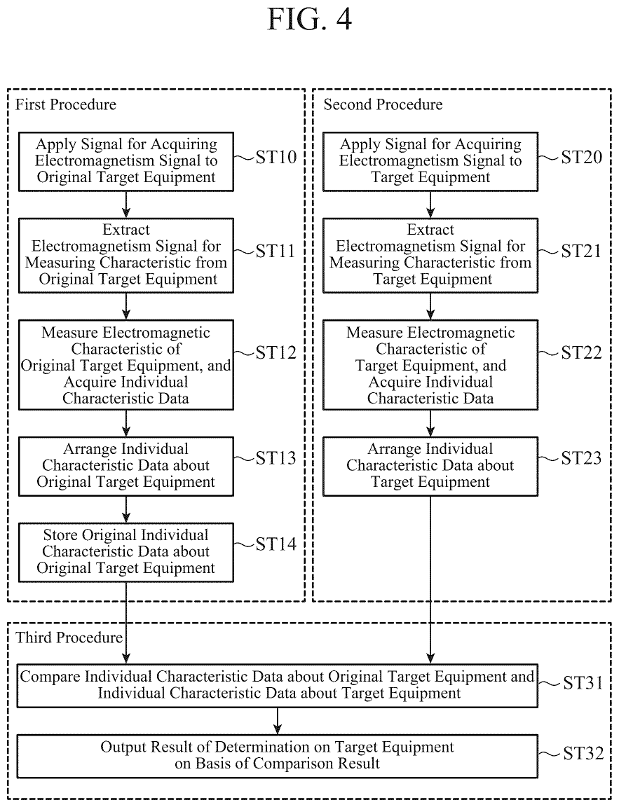

An individual determination device 10 according to Embodiment 2 will be explained on the basis of FIGS. 3 and 4.

While the individual determination device 10 according to Embodiment 1 performs the individual determination on target equipment 20 by receiving an electromagnetic noise produced by the target equipment, the electromagnetic noise being a signal showing an electromagnetic characteristic occurring inevitably, the individual determination device 10 according to Embodiment 2 performs individual determination on target equipment 20 by applying a detection signal to the target equipment 20 and receiving a response signal which is a signal acquired from the target equipment 20 because of the applied detection signal and showing an electromagnetic characteristic.

More specifically, the individual determination device 10 according to Embodiment 2 differs from the individual determination device 10 according to Embodiment 1 in the type of a signal from target equipment 20, the signal being used to perform the individual determination and showing an electromagnetic characteristic, but they are based on the same idea of performing the individual determination.

The individual determination device 10 according to Embodiment 2 includes a reception device 11, a characteristic measurement device 12, a data arrangement device 13, a storage device 14, and a comparison and determination device 15, and further includes a detection signal generation device 16 and a transmission device 17, as shown in FIG. 3.

The individual determination device 10 applies the detection signal for acquiring a response signal from target equipment 20, the response signal being a signal showing an electromagnetic characteristic from the target equipment 20, to the target equipment 20 by means of the detection signal generation device 16 and the transmission device 17, receives the response signal acquired from the target equipment by means of the reception device 11, and performs the individual determination on the target equipment 20.

More specifically, using a response signal which occurs in an interface in the target equipment 20 when the detection signal is applied to the interface in the target equipment 20, the individual determination device 10 performs the individual determination on the target equipment 20.

The response signal occurring in the interface in the target equipment 20 is a signal showing an electromagnetic characteristic which is based on a reflection or impedance characteristic observed in the interface in the target equipment 20.

As an alternative, the response signal acquired from the target equipment 20 may be a signal showing an electromagnetic characteristic which is based on a pass characteristic observed between two different interfaces in the target equipment 20.

An interface in target equipment (20 or 30) is at least a portion where a voltage, a current, or a radiated electromagnetic field is observed when the detection signal is applied thereto, such as a power or communication cable or a terminal of a power or communication cable in the target equipment, or the whole or part of the case of the target equipment.

The power or communication cable or the terminal of the power or communication cable is a cable interface, and the whole or part of the case of the target equipment or the like is an interface other than the cable interface.

The above-mentioned response signal acquired from target equipment is, for example, a signal showing an electromagnetic characteristic which differs depending on factors such as the connection configuration of parts or circuits used in the target equipment, the layer configuration of a printed-circuit board used inside the target equipment, the wiring route for a power supply or signals used inside the target equipment, the wiring route of internal cables used inside the target equipment, the case structure of the target equipment, or the like, even though the target equipment has a similar appearance and a similar function.

Further, even though equipment is produced according to the same design, a signal showing an electromagnetic characteristic different from equipment to equipment occurs in an interface in the target equipment because of variations in each part and a printed-circuit board, the wiring route of internal cables, the assembly of the case, and soon.

The individual determination device 10 according to Embodiment 2 uses an electromagnetic characteristic of a response signal acquired from an interface in target equipment, to measure the response signal, thereby performing the individual determination, such as authenticity determination of whether it is a genuine product or a non-genuine product, individual identification of the target equipment, or authentication of the target equipment.

The detection signal generation device 16 is a portion having a function of outputting the detection signal in the characteristic measurement device 12.

More specifically, the characteristic measurement device 12 has a function of receiving an electromagnetic characteristic signal inputted thereto, the electromagnetic characteristic signal being based on a response signal from the reception device 11, and outputting individual characteristic data showing an electromagnetic individual characteristic of target equipment on the basis of the inputted electromagnetic characteristic signal, and a function as the detection signal generation device 16.

The characteristic measurement device 12 is, for example, a network analyzer or a time domain reflectometry (TDR) measurement device.

In the case where a network analyzer is used as the characteristic measurement device 12, the individual determination device 10 uses a response signal which is based on a reflection or pass characteristic in an interface in target equipment.

In the case where a network analyzer is used as the characteristic measurement device 12, and a response signal based on a reflection characteristic is used, the network analyzer serves as the detection signal generation device 16 to output the detection signal to the transmission device 17, the detection signal being a sinusoidal wave with which to scan over a frequency range in which the network analyzer performs a measurement for the individual determination on target equipment, and also receives an electromagnetic characteristic signal from the reception device 11 which has received a response signal which is based on a reflection signal from an interface in the target equipment which has received the detection signal, displays “a reflection amount versus frequency” in the response signal from the target equipment as individual characteristic data, and outputs the individual characteristic data to the data arrangement device 13.

As an alternative, the individual characteristic data may be “impedance versus frequency” in a response signal from the target equipment, the impedance being determined from a relation with either the output impedance of the transmission device 17 or the input impedance of the reception device 11, or a relation between both of them.

Also in the case where a network analyzer is used as the characteristic measurement device 12, and a response signal based on a pass characteristic is used, the network analyzer serves as the detection signal generation device 16 to output the detection signal to the transmission device 17, the detection signal being a sinusoidal wave with which to scan over a frequency range in which the network analyzer performs a measurement for the individual determination on target equipment, outputs the detection signal to an interface in target equipment from the transmission device 17, receives an electromagnetic characteristic signal from the reception device 11 which has received a response signal which is based on a pass signal occurring in another interface in the target equipment, displays “a pass amount versus frequency” in the response signal from the target equipment as individual characteristic data, and outputs the individual characteristic data to the data arrangement device 13.

In the case where a TDR measurement device is used as the characteristic measurement device 12, a response signal based on an impedance characteristic in an interface in target equipment is used.

The TDR measurement device serves as the detection signal generation device 16 to output the detection signal to the transmission device 17, the detection signal being a step wave with which the TDR measurement device performs a measurement for the individual determination on target equipment, and also receives an electromagnetic characteristic signal from the reception device 11 which has received a response signal which is based on a reflection signal from an interface in the target equipment which has received the detection signal, displays “impedance versus time” in the response signal from the target equipment as individual characteristic data, and outputs the individual characteristic data to the data arrangement device 13.

Further, the individual characteristic data may be “impedance versus distance” in the response signal from the target equipment, the impedance being provided through the conversion of the propagation speed of the detection signal into distance.

Instead of using a network analyzer or a TDR measurement device as the characteristic measurement device 12, a device which serves as the detection signal generation device 16 to output the detection signal to the transmission device 17, the detection signal being an impulse signal with which the device performs a measurement for the individual determination on target equipment, and which also receives an electromagnetic characteristic signal from the reception device 11 which has received a response signal which is based on a reflection signal from an interface in the target equipment which has received the detection signal, and then acquires “a reflection amount versus time” in the response signal from the target equipment as individual characteristic data may be used as the characteristic measurement device 12.

As an alternative, a device which serves as the detection signal generation device 16 to output the detection signal to the transmission device 17, the detection signal being an impulse signal with which the device performs a measurement for the individual determination on target equipment, and outputs the detection signal to an interface in the target equipment from the transmission device 17, and which receives an electromagnetic characteristic signal from the reception device 11 which has received a response signal which is based on a temporal change in a voltage or current observed in another interface in the target equipment, and then acquires “a pass amount versus time” in the response signal from the target equipment as individual characteristic data may be used as the characteristic measurement device 12.

Although the detection signal generation device 16 is configured as the portion having a function of outputting the detection signal in the characteristic measurement device 12, the detection signal generation device 16 may be disposed separately from the characteristic measurement device 12.

The transmission device 17 applies the detection signal from the detection signal generation device 16 to an interface in target equipment.

The transmission device 17 has only to be electrically connected to an interface in target equipment, and be able to propagate the detection signal from the detection signal generation device 16 to the interface in the target equipment.

The transmission device 17 is, for example, a voltage or current probe, an electric or magnetic field probe, or a coupling circuit such as an AMN for power supply terminals or an AAN for signal terminals which is used in an EMC test which is a noise test.

The transmission device 17 may further have an impedance conversion circuit in order to improve the accuracy of measurements of a reflection or impedance characteristic which is observed by an interface in target equipment.

As an alternative, an antenna, an electric or magnetic field probe, or the like may be used as the transmission device 17 in the case where the individual determination device 10 uses a response signal caused by a radiated electromagnetic field occurring from the case of target equipment.

The reception device 11 detects a response signal from target equipment, extracts an electromagnetic signal for measuring an individual characteristic of the target equipment from the response signal detected thereby, and outputs an electromagnetic characteristic signal showing the individual characteristic of the target equipment.

The reception device 11 has only to be electrically connected to an interface in target equipment, and be able to receive a response signal occurring in the interface in the target equipment.

The reception device 11 is, for example, a voltage or current probe, an electric or magnetic field probe, or a coupling circuit such as an AMN for power supply terminals or an AAN for signal terminals which is used in an EMC test which is a noise test.

The reception device 11 may further have an impedance conversion circuit in order to improve the accuracy of measurements of a reflection or impedance characteristic observed in an interface in target equipment.

As an alternative, an antenna, an electric or magnetic field sensor, an electric or magnetic field probe, or the like may be used as the reception device 11 in the case where the individual determination device 10 uses a response signal caused by a radiated electromagnetic field occurring from the case of target equipment.

Although the transmission device 17 and the reception device 11 are disposed separately, a transmission and reception device in which both of them are used together may be alternatively disposed.

In the case where the transmission and reception device is disposed, a switching circuit has only to be disposed between the transmission and reception device, and the detection signal generation device 16 and the characteristic measurement device 12.

More specifically, what is necessary is just to switch between the function, as the characteristic measurement device 12, of receiving an electromagnetic characteristic signal inputted thereto, the electromagnetic characteristic signal being based on a response signal from the reception device 11, and outputting individual characteristic data showing an electromagnetic individual characteristic of target equipment on the basis of the inputted electromagnetic characteristic signal, and the function as the detection signal generation device 16, and to connect one of the functions to the transmission and reception device.

The data arrangement device 13 receives a response signal from target equipment by means of the reception device 11 a number of times, and averages pieces of individual characteristic data from a network analyzer or a TDR measurement device which is used as the characteristic measurement device 12, the pieces of individual characteristic data corresponding response signals which have been received a number of times, to set the average of the pieces of individual characteristic data as individual characteristic data, or extracts individual characteristic data showing a reflection amount, impedance, or a pass amount either greater than or equal to a setting value or less than or equal to a setting value, out of pieces of individual characteristic data showing “a reflection amount versus frequency” or “impedance versus frequency”, “a pass amount versus frequency”, or “impedance versus time” or “impedance versus distance”, to set the individual characteristic data extracted thereby as individual characteristic data.

Because the storage device 14 and the comparison and determination device 15 are substantially the same as the storage device 14 and the comparison and determination device 15 in the individual determination device 10 according to Embodiment 1, a detailed explanation of them will be omitted hereinafter.

Next, an operation of storing original individual characteristic data about original target equipment 30 in the storage device 14, and an operation of performing the individual determination on target equipment 20 in the individual determination device 10 according to Embodiment 2 will be explained on the basis of FIG. 4.

First, a first procedure of storing the original individual characteristic data about the original target equipment 30 in the storage device 14, i.e. a storage procedure will be explained.

As shown in step ST10, the detection signal generation device 16 in the characteristic measurement device 12 is caused to generate the detection signal for causing a response signal to occur in an interface in the original target equipment 30, and the transmission device 17 applies the detection signal from the detection signal generation device 16 to the interface in the original target equipment 30. This step ST10 is a signal application step of applying the detection signal for acquiring a response signal which is a signal showing an electromagnetic characteristic to the original target equipment 30.

When the detection signal is applied to the interface in the original target equipment 30, a response signal occurs in the interface in the original target equipment 30, the response signal is detected by the reception device 11, an electromagnetic signal for measuring an individual characteristic of the original target equipment 30 is extracted from the response signal detected by the reception device 11, and an electromagnetic characteristic signal showing the individual characteristic of the original target equipment 30 is outputted to the characteristic measurement device 12 (step ST11). This step ST11 is an acquisition step of acquiring a response signal which is a signal showing an electromagnetic characteristic from the original target equipment 30.

The response signal from the original target equipment 30 is one from at least an interface such as a power supply interface in the original target equipment 30 or an interface other than the power supply interface.

Next, the characteristic measurement device 12 measures an electromagnetic characteristic of the original target equipment 30 on the basis of the electromagnetic characteristic signal from the reception device 11, and acquires and outputs individual characteristic data showing the electromagnetic individual characteristic of the original target equipment 30 (step ST12). This step ST12 is an acquisition step of acquiring the individual characteristic data about the original target equipment 30.

The individual characteristic data displayed and outputted by the characteristic measurement device 12 shows “the reflection amount versus frequency” or “the impedance versus frequency” in the case where the response signal based on the reflection characteristic is used, shows “the pass amount versus frequency” in the case where the response signal based on the pass characteristic is used, or shows “the impedance versus time” or “the impedance versus distance” in the case where the response signal based on the impedance characteristic is used.

After that, like in the case of the individual determination device 10 according to Embodiment 1, through an arrangement step of arranging the individual characteristic data about the original target equipment 30 (step ST13) and a storage step of storing the original individual characteristic data about the original target equipment 30 (step ST14), the individual characteristic data about the original target equipment 30 is stored as original individual characteristic data in the storage device 14 while being linked to the identification information about the original target equipment 30, and the storage of the original individual characteristic data about the original target equipment 30 in the storage device 14 is completed.

By performing the storage procedure (first procedure) of steps ST10 to ST14 on each of the following pieces of original target equipment: multiple pieces of original target equipment 30 having different model names; and multiple pieces of original target equipment 30 of the same type, but having different serial numbers, the multiple pieces of original individual characteristic data about the multiple types of original target equipment 30 can be stored in the storage device 14.

Next, a second procedure of acquiring the individual characteristic data about target equipment 20 in the individual determination device 10 according to Embodiment 2, i.e. an acquisition procedure, and a third procedure of performing whether or not there is a match between the individual characteristic data about the target equipment 20 and the individual characteristic data about the original target equipment 30, i.e. an individual determination procedure will be explained.

Steps ST20 to ST23 in the second procedure are basically ones in which, in steps ST10 to ST13 in the first procedure, the acquisition of the individual characteristic data about the original target equipment 30 using a response signal occurring in the original target equipment 30 is simply replaced by the acquisition of the individual characteristic data about the target equipment 20 using a response signal occurring in the target equipment 20, as shown in FIG. 4.

More specifically, although a detailed explanation is omitted, step ST20 is a signal application step of applying the detection signal for acquiring a signal showing an electromagnetic characteristic to the target equipment 20 by means of the detection signal generation device 16 and the transmission device 17.

Step ST21 is an acquisition step of acquiring a response signal from the target equipment 20, the step being one in which the reception device 11 acquires an electromagnetic characteristic signal showing an individual characteristic of a response signal acquired from the target equipment 20, and outputs the electromagnetic characteristic signal.

Step ST22 is an acquisition step of acquiring individual characteristic data, the step being one in which the characteristic measurement device 12 acquires individual characteristic data showing the electromagnetic individual characteristic of the target equipment 20 on the basis of the electromagnetic characteristic signal from the reception device 11, and outputs the individual characteristic data.

Step ST23 is an arrangement step in which the data arrangement device 13 arranges the individual characteristic data about the target equipment 20 by eliminating a noise or extracting specific information from the individual characteristic data from the characteristic measurement device 12.

In the third procedure, the comparison and determination device 15 determines whether or not there is a match between the individual characteristic data about the target equipment 20 from the characteristic measurement device 12, the individual characteristic data being acquired in the second procedure and outputted via the data arrangement device 13, and the individual characteristic data in the original individual characteristic data about the original target equipment 30, the original individual characteristic data being acquired in the first procedure and stored in the storage device 14 (step ST31 which is a comparison step on the target equipment 20), like in the case of the individual determination device 10 according to Embodiment 1.

The comparison and determination device 15 performs the individual determination on the target equipment 20 on the basis of a result of the comparison in step ST31, and outputs a result of the determination to the output device 40 (step ST32 which is an individual determination step on the target equipment 20).

In the case of authenticity determination, when there is a match between the individual characteristic data about the target equipment 20 and the individual characteristic data about the original target equipment 30, the determination result is information which is defined as a set of the identification information about the original target equipment 30 and information showing that it is genuine (genuine product).

Further, in the case of authenticity determination, when the individual characteristic data about the original target equipment 30 which matches the individual characteristic data about the target equipment 20 is not present in the storage device 14, the determination result is information showing that it is a fake (non-genuine product).

In addition, in the case of individual identification and in the case of determination of authentication of target equipment, when there is a match between the individual characteristic data about the target equipment 20 and the individual characteristic data about the original target equipment 30, the determination result is information showing that it is target equipment which is based on the identification information about the original target equipment 30 which the target equipment 20 matches.

Further, in the case of individual identification and in the case of determination of authentication of target equipment, when the individual characteristic data about the original target equipment 30 which matches the individual characteristic data about the target equipment 20 does not exist in the storage device 14, the determination result is information showing that it is a target product which is not registered.

The individual determination device 10 according to Embodiment 2 has only to be configured in such a way that the characteristic measurement device 12 acquires individual characteristic data about target equipment showing at least a quantity such as “the reflection amount versus frequency” or “the impedance versus frequency”, “the pass amount versus frequency”, or “the impedance versus time” or “the impedance versus distance.”

The individual determination device 10 according to the Embodiment 2 which is configured in this way also provides the same advantageous effects as those provided by the individual determination device 10 according to Embodiment 1.

Because the individual determination device 10 according to Embodiment 2 includes the detection signal generation device 16 to output the detection signal, and the transmission device 17 to apply the detection signal from the detection signal generation device 16 to an interface in target equipment 20, and performs the individual determination on the target equipment 20 using a response signal acquired from the interface in the target equipment 20 to which the detection signal is applied, the individual determination device can perform the individual determination on the target equipment 20 without a special circuit or function being added to the target equipment 20, and can also perform the individual determination on target equipment 20 which does not include a special circuit or function without influencing the operation of the target equipment 20.

In addition, the individual determination device 10 according to Embodiment 2 can perform the individual determination on target equipment 20 without causing the target equipment 20 to operate, i.e. in a state in which the power supply of the target equipment 20 is turned off.

In the individual determination device 10 according to Embodiment 2, the functions shown in the individual determination device 10 for target equipment according to Embodiment 1, i.e. the functions of, in the reception device 11, receiving an electromagnetic noise which is a signal showing an electromagnetic characteristic inevitably occurring from target equipment 20, and, in the characteristic measurement device 12, acquiring individual characteristic data about the target equipment 20 may be added to components which constitute the individual determination device 10.

More specifically, the individual determination device 10 performs the individual determination on target equipment 20 on the basis of both a signal showing an electromagnetic characteristic inevitably occurring from an interface in the target equipment 20, and a signal showing an electromagnetic characteristic, the signal being a response signal acquired from the interface in the target equipment 20.

It is to be understood that an arbitrary combination of embodiments can be made, a change can be made in an arbitrary component of each of the embodiments, or an arbitrary component in each of the embodiments can be omitted.

### INDUSTRIAL APPLICABILITY

The individual determination device 10 for target equipment according to the present disclosure is suitable for performing the individual determination, such as authenticity determination of whether target equipment is a genuine product or a non-genuine product, individual identification of target equipment, or authentication of target equipment.

### REFERENCE SIGNS LIST

10: Individual determination device, 11: Reception device, 12: Characteristic measurement device, 13: Data arrangement device, 14: Storage device, 15: Comparison and determination device, 16: Detection signal generation device, 17: Transmission device, 20: Target equipment, 30: Original target equipment, and 40: Output device.

What is claimed is:

1. An individual determination device for target equipment, comprising:
a coupling circuit that is electrically connected to an interface in target equipment, the coupling circuit being configured to detect a signal showing an electromagnetic characteristic based on a conduction noise that is conducted to the interface in target equipment, to extract an electromagnetic characteristic signal showing an individual characteristic of the target equipment, from the conduction noise detected thereby, and to output the electromagnetic characteristic signal;
a characteristic measurement device to receive the electromagnetic characteristic signal from the coupling circuit, and to output individual characteristic data showing the individual characteristic of the target equipment on a basis of the electromagnetic characteristic signal received from the coupling circuit;
a storage device to store individual characteristic data showing an electromagnetic individual characteristic of original target equipment; and
a comparison and determination device to compare the individual characteristic data from the characteristic measurement device and the individual characteristic data stored in the storage device, and to perform individual determination on the target equipment.

2. An individual determination device for target equipment, comprising:
a coupling circuit that is electrically connected to an interface in target equipment, the coupling circuit being configured to detect a signal showing an electromagnetic characteristic based on either a reflection characteristic or an impedance characteristic, observed in the interface in the target equipment, to extract an electromagnetic characteristic signal showing an individual characteristic of the target equipment, from the signal detected thereby, and to output the electromagnetic characteristic signal;
a characteristic measurement device to receive the electromagnetic characteristic signal from the coupling circuit, and to output individual characteristic data showing the individual characteristic of the target equipment on a basis of the electromagnetic characteristic signal received from the coupling circuit;
a storage device to store individual characteristic data showing an electromagnetic individual characteristic of original target equipment; and
a comparison and determination device to compare the individual characteristic data from the characteristic measurement device and the individual characteristic data stored in the storage device, and to perform individual determination on the target equipment.

3. An individual determination device for target equipment, comprising:
a coupling circuit that is electrically connected to an interface in target equipment, the coupling circuit being configured to detect a signal showing an electromagnetic characteristic based on a pass characteristic observed between two different interfaces in the target equipment, to extract an electromagnetic characteristic signal showing an individual characteristic of the target equipment, from the signal detected thereby, and to output the electromagnetic characteristic signal;
a characteristic measurement device to receive the electromagnetic characteristic signal from the coupling circuit, and to output individual characteristic data showing the individual characteristic of the target equipment on a basis of the electromagnetic characteristic signal received from the coupling circuit;
a storage device to store individual characteristic data showing an electromagnetic individual characteristic of original target equipment; and
a comparison and determination device to compare the individual characteristic data from the characteristic measurement device and the individual characteristic data stored in the storage device, and to perform individual determination on the target equipment.

4. The individual identification device for target equipment according to claim 1, wherein
the interface in the target equipment is at least a portion where a voltage or a current is observed, such as a power or communication cable or a terminal of a power or communication cable in the target equipment, or a whole or part of a case of the target equipment.

5. The individual identification device for target equipment according to claim 2, wherein
in a case where the signal showing the electromagnetic characteristic, detected by the coupling circuit, is a signal showing the reflection characteristic, the individual characteristic data includes reflection amount versus frequency.

6. The individual identification device for target equipment according to claim 2, wherein
in a case where the signal showing the electromagnetic characteristic, detected by the coupling circuit, is a signal showing the reflection characteristic, the individual characteristic data includes reflection amount versus time.

7. The individual identification device for target equipment according to claim 2, wherein
in a case where the signal showing the electromagnetic characteristic, detected by the coupling circuit, is a signal showing the impedance characteristic, the individual characteristic data includes impedance versus frequency.

8. The individual identification device for target equipment according to claim 2, wherein
in a case where the signal showing the electromagnetic characteristic, detected by the coupling circuit, is a signal showing the impedance characteristic, the individual characteristic data includes impedance versus time.

9. The individual identification device for target equipment according to claim 1, wherein
the individual characteristic data from the characteristic measurement device, which is inputted to the comparison and determination device, is a result of, in a data arrangement device, arranging the individual characteristic data from the characteristic measurement device by eliminating a noise or extracting specific information from the individual characteristic data from the characteristic measurement device.

10. The individual identification device for target equipment according claim 1, wherein
the individual characteristic data stored in the storage device is stored as original individual characteristic data to which identification information shown by a model name, a serial number, or the like of the original target equipment is linked, and
when the comparison between the individual characteristic data from the characteristic measurement device and the individual characteristic data in the original individual characteristic data stored in the storage device shows a match, the comparison and determination device outputs the identification information about the original target equipment in the original individual characteristic data.

11. An individual determination method for target equipment comprising:
an acquisition procedure of acquiring individual characteristic data about target equipment, the acquisition procedure including: acquiring a signal showing an electromagnetic characteristic, in which a coupling circuit electrically connected to an interface in target equipment detects a signal showing an electromagnetic characteristic based on a conduction noise that is conducted to the interface in target equipment, either a reflection characteristic or an impedance characteristic, or a pass characteristic, observed in the interface in the target equipment, extracts an electromagnetic characteristic signal showing an individual characteristic of the target equipment from the signal detected thereby, and outputs the electromagnetic characteristic signal, and acquiring individual characteristic data about the target equipment, in which a characteristic measurement device acquires and outputs individual characteristic data showing an electromagnetic individual characteristic of the target equipment on a basis of the electromagnetic characteristic signal from the coupling circuit; and
an individual determination procedure of, in a comparison and determination device, comparing the individual characteristic data about the target equipment acquired in the acquisition procedure with individual characteristic data about original target equipment stored in a storage device, and performing individual determination on the target equipment.

12. The individual determination method for target equipment according to claim 11, wherein
the acquisition procedure includes arranging the individual characteristic data about the target equipment, which arranges the individual characteristic data about the target equipment from the characteristic measurement device by eliminating a noise or extracting specific information from the individual characteristic data about the target equipment outputted by the characteristic measurement device, and outputs the arranged individual characteristic data to the comparison and determination device.

13. The individual determination method for target equipment according to claim 11, wherein
the individual determination method further includes: a storage procedure of storing original individual characteristic data about the original target equipment in the storage device, the storage procedure including:
acquiring a signal showing an electromagnetic characteristic, in which the coupling circuit detects a signal showing an electromagnetic characteristic based on a conduction noise that is conducted to the interface in target equipment, either a reflection characteristic or an impedance characteristic, or a pass characteristic, observed in the interface in the target equipment, extracts an electromagnetic characteristic signal showing an individual characteristic of the original target equipment from the signal detected thereby, and outputs the electromagnetic characteristic signal;
acquiring the individual characteristic data about the original target equipment, in which the characteristic measurement device acquires the individual characteristic data showing an electromagnetic individual characteristic of the original target equipment on a basis of the electromagnetic characteristic signal of the original target equipment, from the coupling circuit, and outputting the individual characteristic data; and
storing the individual characteristic data about the original target equipment stored in the storage device, as original individual characteristic data, with the individual characteristic data being linked to identification information shown by a model name, a serial number, or the like of the original target equipment.

14. The individual determination method for target equipment according to claim 13, wherein
the acquisition procedure includes arranging the individual characteristic data about the target equipment, which arranges the individual characteristic data about the target equipment from the characteristic measurement device by eliminating a noise or extracting specific information from the individual characteristic data about the target equipment outputted by the characteristic measurement device, and outputs the arranged individual characteristic data to the comparison and determination device, and
the storage procedure includes arranging the individual characteristic data about the original target equipment, which arranges the individual characteristic data about the original target equipment from the characteristic measurement device by eliminating a noise or extracting specific information from the individual characteristic data about the original target equipment outputted by the characteristic measurement device, and outputs the arranged individual characteristic data to the storage device.

15. The individual determination method for target equipment according to claim 13, wherein
the individual determination procedure includes outputting the identification information in the original individual characteristic data about the original target equipment when there is a match between the individual characteristic data about the target equipment acquired in the acquisition procedure and the individual characteristic data about the original target equipment stored in the storage device.

16. The individual determination method for target equipment according to claim 11, wherein
the interface in the target equipment is at least a portion where a voltage, or a current is observed, such as a power or communication cable or a terminal of a power or communication cable in the target equipment, or a whole or part of a case of the target equipment.
